(19) United States
(12) Patent Application Publication
(10) Pub. No.: US 2020/0043232 A1
(43) Pub. Date: Feb. 6, 2020

(54) EXPORTING NON-MESH COMPONENTS WHEN EXPORTING 3D OBJECTS TO 3D FILE FORMATS

(71) Applicant: MICROSOFT TECHNOLOGY LICENSING, LLC, Redmond, WA (US)

(72) Inventors: Prateek AGRAWAL, Hyderabad (IN); Bikash Ranjan SWAIN, Hyderabad (IN); Hindol ADHYA, Hyderabad (IN); Alok AGRAWAL, Hyderabad (IN); Saurabh SHRIVASTAVA, Hyderabad (IN)

(73) Assignee: MICROSOFT TECHNOLOGY LICENSING, LLC, Redmond, WA (US)

(21) Appl. No.: 16/205,199

(22) Filed: Nov. 29, 2018

Related U.S. Application Data
(60) Provisional application No. 62/712,918, filed on Jul. 31, 2018.

(51) Int. Cl. G06T 19/00; G06T 17/20; G06F 16/11; G06F 16/14

(52) U.S. Cl. CPC G06T 19/00; G06T 17/20; G06F 17/2735; G06F 16/148; G06F 16/116

(57) ABSTRACT

A method and system for exporting a 3D object in an application to a file having a 3D file format is disclosed. The method includes a receiving a request for exporting a 3D object in an application to a file having a 3D file format where the 3D object includes a plurality of components. Upon receiving the request, the components are examined to determine if any of them are a 2D text component. When it is determined that at least one of the components is a 2D text component, a database may be referenced to identify a text character that corresponds to the 2D text component, before replacing the 2D text component with a corresponding 3D model in the file.

### CROSS REFERENCE TO RELATED APPLICATION

This application claims the benefit of priority to U.S. Provisional Application No. 62/712,918, entitled “Method of Exporting Non-Mesh Components When Exporting 3D Objects to 3D File Formats,” filed on Jul. 31, 2018, the entirety of which is incorporated by reference herein.

### TECHNICAL FIELD

This disclosure relates generally to exporting three-dimensional (3D) objects to 3D file formats and, more particularly, to a method of exporting non-mesh components, such as text contained in 3D objects when exporting a 3D object to a 3D file format.

### BACKGROUND

The type of content used to present information has evolved over time. Apart from text and media-based content, such as images and videos, 3D objects have recently started being used more often to present information. Sometimes, these 3D objects (for example, 3D models) are exported from 3D applications to 3D file formats and used to showcase an actual physical product in digital format or highlight business insights using volumetric visualization such as 3D charts.

In some 3D applications, objects are represented as part of scenes. A 3D object in the scene may be represented by sets of polygons referred to for example as mesh. These meshes are arranged together to give an impression of a solid object in the 3D space. However, some 3D scenes contain non-mesh components such as text (e.g., used for labeling) as part of the scene. These components are generally created programmatically in the application and may not have any meshes. When a 3D scene containing non-mesh components is exported from an application to a 3D file format, non-mesh component may not be exported. This results in loss of data and distorts the exported scene.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a graphical user interface (GUI) screen of an example 3D object which includes non-mesh components.

FIG. 2 is a GUI screen showing a 3D file format corresponding to the 3D object of FIG. 1 exported using a prior art method of exporting 3D objects to 3D file formats.

FIG. 3 is a flow diagram for a method of exporting non-mesh text components contained in a 3D object when exporting the 3D object to a file having a 3D file format.

FIG. 4 is a block diagram of an examplary computer system upon which aspects of this disclosure may be implemented.

### SUMMARY

In one general aspect, the instant application describes a method for exporting a 3D object in an application to a file having a 3D file format, the method including receiving a request for exporting a 3D object in an application to a file having a 3D file format, the 3D object including a plurality of components, examining the plurality of components to determine if at least one of the plurality of components is a two-dimensional (2D) text component, upon determining that at least one of the plurality of components is a 2D text component, referencing a database to identify a text character that corresponds to the at least one 2D text component, and replacing the identified text character with a corresponding 3D model in the file.

In another general aspect, the instant application describes a device that includes one or more processors, and a memory in communication with the one or more processors, the memory comprising executable instructions that, when executed by the one or more processors, cause the device to perform functions of receiving a request for exporting a 3D object in an application to a file having a 3D file format, the 3D object including a plurality of components, examining the plurality of components to determine if at least one of the plurality of components is a 2D text component, upon determining that at least one of the plurality of components is a 2D text component, referencing a database to identify a text character that corresponds to the at least one 2D text component, and replacing the identified text character with a corresponding 3D model in the file.

In another general aspect, the instant application describes an apparatus including one or more processor means, and memory means in communication with the one or more processors, the memory comprising executable instructions that, when executed by, the one or more processors, cause the device to receive a request for exporting a 3D object in an application to a file having a 3D file format, the 3D object including a plurality of components, examine the plurality of components to determine if at least one of the plurality of components is a two-dimensional (2D) text component, upon determining that at least one of the plurality of components is a 2D text component, reference a database to identify a text character that corresponds to the at least one 2D text component, and replace the identified text character with a corresponding 3D model in the file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

In an example, this description is related to a method for exporting a 3D object in an application to a 3D file format which includes converting non-mesh components of the 3D object such as text, to mesh-components such that those non-mesh components are also included in the 3D file format generated. Currently, applications that export 3D objects to 3D file formats suffer from the technical problem of failing to convert non-mesh components of the 3D objects to viewable components in the 3D file format. For example, if a 3D object includes text, when exported, the resulting 3D file format does not display the text. In an example, this description provides the technical solution for examining the 3D object to determine if it includes at least one non-mesh text component, converting the non-mesh text component into a mesh-based text component, and adding meta data related to the mesh-based text component to the 3D file format such that a 3D viewer can show the 3D object with the text component.

As will be understood by persons of skill in the art upon reading this disclosure, benefits and advantages provided by such implementations can include, but are not limited to, improving accuracy and representation of the exported 3D object in an efficient and user-friendly manner.

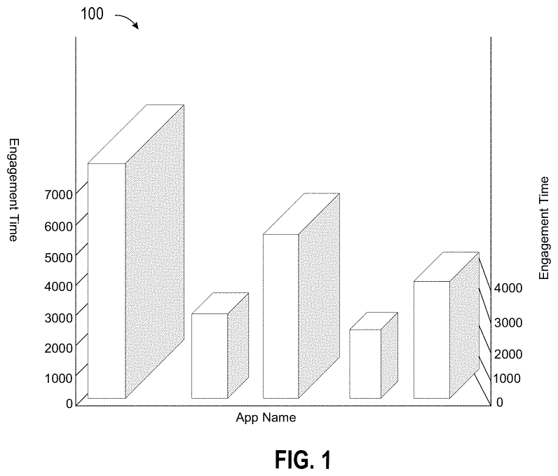

Referring now to the drawings, FIG. 1 shows a GUI screen 100 of an examplary 3D object, which includes non-mesh components. The non-mesh components include multiple lines (shown as grids in the 3D bar chart) and texts used to represent the axes labels' name and quantity numbers for the grids. This is because in applications such as mixed reality (MR) applications, objects are represented as part of scenes and often 3D objects in the scene are represented by a set of polygons referred to, for example as mesh. These meshes are arranged together to give an impression of a solid object in the 3D space. However, there are times, such as in the 3D bar chart of FIG. 1, when non-mesh components such as lines (used for connecting two points in space) and text (used for labeling items) are used as part of the scene in MR applications. These non-mesh components are usually created programmatically in the application and do not have any meshes.

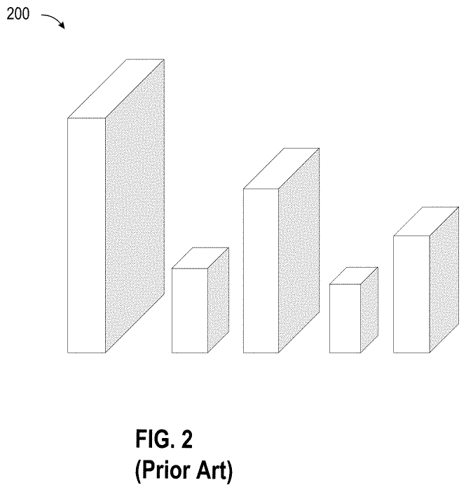

When a scene containing such non-mesh components is exported from the MR application to a file having a 3D file format, such as the GL Transmission Format (GLTf) to be used in other applications, non-mesh components may not be exported. This is shown in the bar chart of FIG. 2 which depicts a GUI screen 200 displaying a file having a 3D file format corresponding to the 3D object of FIG. 1. The 3D file format of FIG. 2 was exported using a prior art method of exporting 3D objects to 3D file formats. As shown in the GUI screen 200 FIG. 2, the lines and texts included in the GUI screen 100 disappear when exported to a 3D file format using prior art exporters. This results in loss of data, which in instances such as the 3D bar chart of screen 200 may turn the 3D object unusable since a bar chart without grid lines and labels conveys very little useful information.

In recent years, some 3D exporters have been developed that include mechanisms for exporting some non-mesh line components. However, these exporters still lack the capability to provide the technical solution of exporting non-mesh text components accurately and efficiently.

In an example, the solution presented in this disclosure enables exporting non-mesh 2D text components from an application as part of a 3D object being exported into a file having a 3D file format. Texts are generally displayed in 3D scenes using user interface (UI) text which does not have any mesh component information, because it is a 2D text. The technical solution may identify one or more 2D texts in the scene and replace them with 3D text objects, such that words of text are recreated using mesh components, which may also be referred to as prefabs. For example, the text “2000” may be replaced by 1 prefab for “2”, followed by 3 prefabs for “0” positioned one after another to recreate the text “2000”.

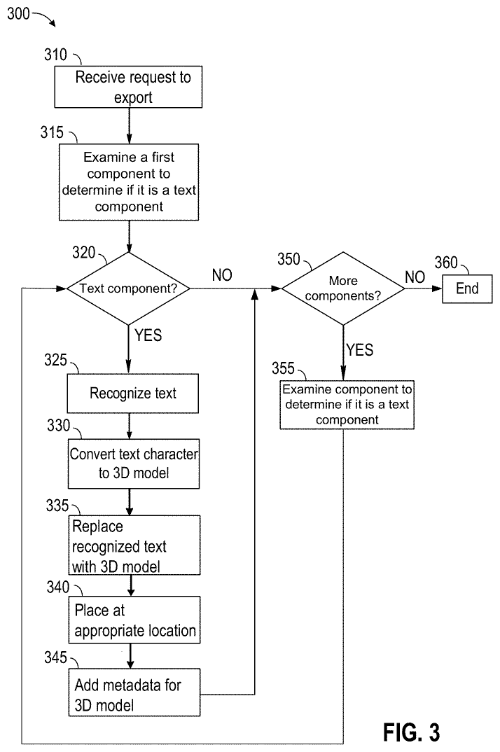

FIG. 3 is a flow diagram depicting an example method 300 for exporting non-mesh text components contained in a 3D object when exporting the 3D object to a file having a 3D file format. At 310, the method 300 begins by receiving a request to export a 3D object to a file having a 3D file format. The request may be sent by a user utilizing an application, such as a MR application. For example, the application may be an engine for developing 3D scenes. The engine may include an option that, once selected by a user, can export a user-selected scene to a file having a 3D file format. This may be done to enable the use of the scene in an alternative application. The alternative application may itself be a 3D viewer or it may include a 3D viewer. For example, the user may intend to view the 3D scene in an application such as PowerPoint®, which can include 3D viewing capabilities. Alternatively, the request may originate automatically from an application used to develop and/or view the 3D scene. In yet another alternative, the request may originate from an application and/or a user of that application that intends to use the exported 3D scene.

Once the request for exporting the 3D object is received, method 300 proceeds to step 315 to examine a first component in a list of components that make up the 3D object to determine if the first component is a text component. This is achieved, in one implementation, by examining the component to determine if a tag identifier identifying the component indicates that the component is a text (e.g., a 2D type text). This is because, in some applications, 3D objects include a hierarchical model for the components that make up the 3D object. The hierarchical model may include a tag identifier that identifies each type of component. For example, mesh-components may have a tag identifier identifying them as a type mesh, while 2D text components may be identified by a tag identifier indicating a 2D type text. The tag identifier may be included as part of a data structure that accompanies each 3D object. When a tag identifier is available, method 300 simply examines that identifier for the component to determine if it is a text component.

In some instances, the 3D object may include components that do not have tag identifiers. For example, the 3D object may include an image that includes text. In other cases, the 3D object may have been developed with an application that does not utilize tag identifiers. In such instances, method 300 may utilize an optical character recognition (OCR) tool to examine the component and extract any possible text included in the component. The text may be extracted by the OCR tool as a string and stored in memory for later conversion. Other methods of identifying text components may also be used.

After examining the first component, method 300 proceeds to decide if the component is a text component (or includes text), at 320. When it is decided that the component is a text component (either through the tag identifier or by using OCR), method 300 proceeds to recognize the text, at 320. This may be achieved, by looking up the identified text in a dictionary and/or to recognize a match between the text and a letter, number, symbol or any other text character stored in the data structure of the library. For example, the text “R” may be looked up in the dictionary to identify the letter R. The dictionary may include one or more letters of the alphabet, and digits from zero to nine, in addition to commonly used symbols (e.g., coma, semicolon, etc.) and any other text character. Moreover, the dictionary, may include letters that correspond to alphabets in more than one language.

In one implementation, the steps of method 300 may be performed separately for each character in a text string. For example, if the 3D object includes the word “Label”, each letter in the word may be recognized as a separate component and thus examined and looked up separately. Alternative, each word may be identified as one component and the step of identifying the letters in the word may be repeated for each character in the word until the characters for the entire word are identified.

Once the character(s) are identified, method 300 proceeds to convert the identified character to a 3D model developed for that character, at 330, by examining a 3D model data structure to find a corresponding 3D model for the identified character. The 3D model data structure has been developed for the solution presented in this disclosure, such that each character included in the dictionary has a corresponding 3D model. For example, the letter R identified in the dictionary, has a corresponding 3D model that can be used for displaying the letter R in a file having a 3D file format. In one implementation, each character in the dictionary has a character identifier that corresponds to an identifier for one of the 3D models in the 3D model library. In this manner, once a character is recognized at step 325, the character identifier can simply be used to lookup the corresponding identifier in the 3D model data structure.

After the corresponding 3D model for the recognized text is located, method 300 proceeds to replace the text component in the exported file with the corresponding 3D model, at 335. In replacing the text component, method 300 determines the location of the text component in the 3D object and places the corresponding 3D model at a location in the exported file that corresponds to the location of the text component in the original 3D object, at 340. In this manner, method 300 ensures that the exported file looks the same way as the original 3D object. After the identified character has been replaced, method 300 proceeds to add metadata for the 3D model into the exported file, at 345, so that a 3D viewer can view the object properly.

In instances when method 300 determines, at 320, that the component being examined is not a text component and after adding metadata for the 3D model, at 345, method 300 proceeds to determine if there are any other unexamined components in the 3D object, at 350. This occurs to ensure unexamined components in the 3D object are examined and included in the exported file.

When it is determined, at 350, that the 3D object includes more components, method 300 proceeds to examine the next component to determine if it is a text component, at 355 and to repeat the same steps (320 through 345) to ensure that it is converted appropriately. However, if it is determined at this stage that the 3D object does not include any other unexamined components, method 300 proceeds to end, at 360.

Below is a portion of an exemplary code for exporting 2D text components in a 3D object to a file having a 3D file format:

Let Alphabets<string, GameObject> be dictionary where the key is ascii
character and value is its corresponding 3D object containing mesh
Let TextList be the list of all Text objects
MINTHICKNESS = 0.0001 // setting this thickness of 3DText looks flat
List<GameObject> AlphabetList = new List<GameObject>( );
Foreach(TextObject in TextList):
Foreach (character in TextObject.Text)
AlphabetToPlace = Alphabets[character]
AlphabetToPlace.position = character.position
AlphabetToPlace.orientation = character.orientation
AlphabetToPlace.scale.x = character.scale.x
AlphabetToPlace.scale.y = character.scale.y
AlphabetToPlace.scale.z = MINTHICKNESS
AlphabetToPlace.parent = character.parent
AlphabetList.Add (AlphabetToPlace)
End Foreach
End Foreach
Export(AlphabetList)
Destroy(AlphabetList) // Destroy items in list after export is done

The above exemplary code logic can add metadata information for the text as shown below.

“meshes”: [

{

“primitives”: [

{

“attributes”: {

“POSITION”: 132,
“NORMAL”: 133,
“TANGENT”: 134,
“TEXCOORD_0”: 135,
“COLOR_0”: 136

},
“indices”: 137,
“material”: 22

}

],
“name”: “A” // Here A is name of the 3d Alphabet
corresponding to character A.

},

The same metadata information may be added to the nodes section so that it can be read by any 3D viewer application, as shown below.

{

“mesh”: 22,
“rotation”: [

0.0,
−1.0,
0.0,
0.0

],
“scale”: [

0.301672,
0.2871333,
0.001

],
“translation”: [

−25.95,
0.0,
0.0

],
“name”: “A”

}.

In this manner, any text present in a 3D scene can be converted to 3D objects and exported with mesh-based components when exporting a 3D scene to a file having a 3D file format. The process is accurate, simple and efficient and prevents loss of data.

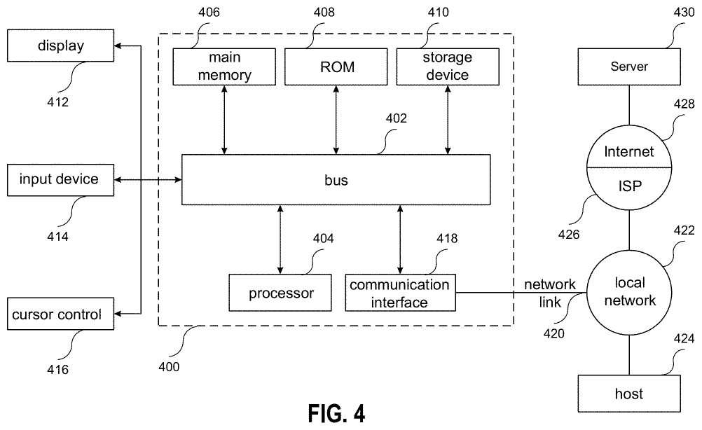

FIG. 4 is a block diagram showing an exemplary computer system 400 upon which aspects of this disclosure may be implemented. Computer system 400 includes a bus 402 or other communication mechanism for communicating information, and a processor 404 coupled with bus 402 for processing information. Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. The computer system 400 can implement, for example, one or more steps of the method 300 for exporting non-mesh text components contained in a 3D object when exporting the 3D object to a file having a 3D file format.

Computer system 400 can further include a read only memory (ROM) 408 or other static storage device coupled to bus 402 for storing static information and instructions for processor 404. A storage device 410, such as a flash or other non-volatile memory, can be coupled to bus 402 for storing information and instructions.

Computer system 400 may be coupled via bus 402 to a display 412, such as a liquid crystal display (LCD), for displaying information. One or more user input devices, such as the exemplary user input device 414 can be coupled to bus 402, and can be configured for receiving various user inputs, such as user command selections and communicating these to processor 404, or to a main memory 406. The user input device 414 can include physical structure, or virtual implementation, or both, providing user input modes or options, for controlling, for example, a cursor, visible to a user through display 412 or through other techniques, and such modes or operations can include, for example virtual mouse, trackball, or cursor direction keys.

The computer system 400 can include respective resources of processor 404 executing, in an overlapping or interleaved manner, respective program instructions. Instructions may be read into main memory 406 from another machine-readable medium, such as storage device 410. In some examples, hard-wired circuitry may be used in place of or in combination with software instructions. The term “machine-readable medium” as used herein may refer to for example any medium that participates in providing data that causes a machine to operate in a specific fashion. Such a medium may take forms, including but not limited to, non-volatile media, volatile media, and transmission media. Non-volatile media can include, for example, optical or magnetic disks, such as storage device 410. Transmission media can include optical paths, or electrical or acoustic signal propagation paths, and can include acoustic or light waves, such as those generated during radio-wave and infra-red data communications, that are capable of carrying instructions detectable by a physical mechanism for input to a machine.

Computer system 400 can also include a communication interface 418 coupled to bus 402, for two-way data communication coupling to a network link 420 connected to a local network 422. Network link 420 can provide data communication through one or more networks to other data devices. For example, network link 420 may provide a connection through local network 422 to a host computer 424 or to data equipment operated by an Internet Service Provider (ISP) 426 to access through the Internet 428 a server 430, for example, to obtain code for an application program.

Devices and methods for exporting 3D object in an application to a file having a 3D file format are described. Devices can include a device including one or more processors, and a memory in communication with the one or more processors, the memory comprising executable instructions that, when executed by, the one or more processors, cause the device to perform functions of receiving a request for exporting a 3D object in an application to a file having a 3D file format, the 3D object including a plurality of components; examining the plurality of components to determine if at least one of the plurality of components is a two-dimensional (2D) text component; upon determining that at least one of the plurality of components is a 2D text component, referencing a database to identify a text character that corresponds to the at least one 2D text component; and replacing the 2D text component with a corresponding 3D model.

In one implementation, determining if at least one of the plurality of components is a 2D text component includes examining a tag identifier of each of the plurality of components. In another implementation, the tag identifier includes an identifier for 2D type text. In yet another implementation, the text character is identified by looking up the 2D text component in a dictionary.

In one implementation, the executable instructions stored in the memory of the device, when executed by the one or more processors may further cause the device to perform functions of identifying the corresponding 3D model which corresponds to the identified text character by looking up the identified text character in a data structure containing 3D text models.

In one implementation, the executable instructions stored in the memory of the device, when executed by the one or more processors may further cause the device to perform functions of placing the corresponding 3D model at an appropriate location in the file.

In one implementation, the executable instructions stored in the memory of the device, when executed by the one or more processors may further cause the device to perform functions of adding metadata relating to the corresponding 3D model to the file.

In one implementation, disclosed devices may include an apparatus including one or more processor means, and memory means in communication with the one or more processor means, the memory comprising executable instructions that, when executed by, the one or more processor means, cause the device to receive a request for exporting a 3D object in an application to a file having a 3D file format, the 3D object including a plurality of components; examine the plurality of components to determine if at least one of the plurality of components is a two-dimensional (2D) text component; upon determining that at least one of the plurality of components is a 2D text component, reference a database to identify a text character that corresponds to the at least one 2D text component; and replace the 2D text component with a corresponding 3D model.

In one implementation, determining if at least one of the plurality of components is a 2D text component includes examining a tag identifier of each of the plurality of components. In another implementation, the tag identifier includes an identifier for 2D type text. In yet another implementation, the text character is identified by looking up the 2D text component in a dictionary.

In one implementation, the executable instructions stored in the memory means of the device, when executed by the one or more processor means may further cause the apparatus to perform functions of placing the corresponding 3D model at an appropriate location in the file.

In one implementation, the executable instructions stored in the memory means of the device, when executed by the one or more processor means may further cause the apparatus to perform functions of placing the corresponding 3D model at an appropriate location in the file.

In one implementation, the executable instructions stored in the memory means of the device, when executed by the one or more processor means may further cause the apparatus to perform functions of adding metadata relating to the corresponding 3D model to the file.

In one implementation, methods may include a method for exporting a 3D object in an application to a file having a 3D file format including receiving a request for exporting a 3D object in an application to a file having a 3D file format, the 3D object including a plurality of components; examining the plurality of components to determine if at least one of the plurality of components is a two-dimensional (2D) text component; upon determining that at least one of the plurality of components is a 2D text component, referencing a database to identify a text character that corresponds to the at least one 2D text component; and replacing the 2D text component with a corresponding 3D model.

In one implementation, the method may further comprise identifying the corresponding 3D model which corresponds to the identified text character by looking up the identified text character in a data structure containing 3D text models.

In one implementation, the method may further comprise placing the corresponding 3D model at an appropriate location in the file.

In one implementation, the method may further comprise adding metadata relating to the corresponding 3D model to the file.

In one implementation, determining if at least one of the plurality of components is a 2D text component includes examining a tag identifier of each of the plurality of components. In another implementation, the tag identifier includes an identifier for 2D type text. In yet another implementation, the text character is identified by looking up the 2D text component in a dictionary.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-3) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are platform-independent, meaning that the techniques may be implemented on a variety of computing platforms having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A device comprising:
one or more processors; and
a memory in communication with the one or more processors, the memory comprising executable instructions that, when executed by, the one or more processors, cause the device to perform functions of:
receiving a request for exporting a three-dimensional (3D) object in an application to a file having a 3D file format, the 3D object including a plurality of components;
determining if at least one component of the plurality of components is a two-dimensional (2D) text component by examining the plurality of components;
upon determining that at the one component is a 2D text component, referencing a database to identify a text character that corresponds to the one component; and
replacing the identified text character with a corresponding 3D model in the file.

2. The device of claim 1, wherein determining if at least the one component of the plurality of components is a 2D text component includes examining a tag identifier of the one component to determine if the tag identifier corresponds to a 2D type text.

3. The device of claim 2, wherein the executable instructions when executed by, the one or more processors, further cause the device to perform functions of exporting the 3D object to the file upon determining that there are no 2D text components in the plurality of components.

4. The device of claim 1, wherein the text character is identified by looking up the 2D text component in a dictionary.

5. The device of claim 1, wherein the executable instructions when executed by, the one or more processors, further cause the device to perform functions of identifying the corresponding 3D model by looking up the identified text character in a data structure containing 3D text models.

6. The device of claim 1, wherein the executable instructions when executed by, the one or more processors, further cause the device to perform functions of placing the corresponding 3D model at an appropriate location in the file.

7. The device of claim 1, wherein the executable instructions when executed by, the one or more processors, further cause the device to perform functions of adding metadata relating to the corresponding 3D model to the file.

8. A method for exporting a 3D object in an application to a file having a 3D file format comprising:
receiving a request for exporting a three-dimensional (3D) object in an application to a file having a 3D file format, the 3D object including a plurality of components;
determining if at least one of the plurality of components is a two-dimensional (2D) text component by examining the plurality of components;
upon determining that at least one of the plurality of components is a 2D text component, referencing a database to identify a text character that corresponds to the at least one 2D text component; and
replacing the identified text character with a corresponding 3D model in the file.

9. The method of claim 8, wherein determining if at least one of the plurality of components is a 2D text component includes examining a tag identifier of each of the plurality of components.

10. The method of claim 9, wherein the tag identifier includes an identifier for 2D type text.

11. The method of claim 8, wherein the text character is identified by looking up the 2D text component in a dictionary.

12. The method of claim 8, further comprising identifying the corresponding 3D model by looking up the identified text character in a data structure containing 3D text models.

13. The method of claim 8, further comprising placing the corresponding 3D model at an appropriate location in the file.

14. The method of claim 8, further comprising adding metadata relating to the corresponding 3D model to the file.

15. An apparatus comprising:
a processing means; and
a memory means readable by the processing means and comprising instructions stored therein to cause the processing means to:
receive a request for exporting a three-dimensional (3D) object in an application to a file having a 3D file format, the 3D object including a plurality of components;
determine if at least one of the plurality of components is a two-dimensional (2D) text component by examining the plurality of components;
upon determining that at least one of the plurality of components is a 2D text component, reference a database to identify a text character that corresponds to the at least one 2D text component; and
replace the identified text character with a corresponding 3D model in the file.

16. The apparatus of claim 15, wherein determining if at least one of the plurality of components is a 2D text component includes examining a tag identifier of each of the plurality of components to determine if the tag identifier corresponds to a 2D text identifier.

17. The apparatus of claim 15, wherein the text character is identified by looking up the 2D text component in a dictionary.

18. The apparatus of claim 15, wherein the instructions stored therein further cause the processing means to identify the corresponding 3D model by looking up the identified text character in a data structure containing 3D text models.

19. The apparatus of claim 15, wherein the instructions stored therein further cause the processing means to place the corresponding 3D model at an appropriate location in the file.

20. The apparatus of claim 15, wherein the instructions stored therein further cause the processing means to add metadata relating to the corresponding 3D model to the file.
